(19) United States
(12) Patent Application Publication
(10) Pub. No.: US 2007/0247578 A1
(43) Pub. Date: Oct. 25, 2007

(54) Liquid crystal display

(75) Inventors: Chiu-Lien Yang, Miao-Li (TW); Wei-Yi Ling, Miao-Li (TW); Chia-Lung Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/788,161

(22) Filed: Apr. 19, 2007

(30) Foreign Application Priority Data
Apr. 19, 2006 (CN) 200610060386.0

(51) Int. Cl. G02F 1/141; G02F 1/1335

(52) U.S. Cl. 349/134; 349/119

(57) ABSTRACT

An LCD device (2) includes a first substrate (21), a second substrate (22), and a liquid crystal layer (23) having liquid crystal molecules is interposed between the first and second substrates. A pretilt angle of the liquid crystal layer adjacent to one of the substrates is 0° to 15°, and a pretilt angle of the liquid crystal layer adjacent to the other substrate is 75° to 90°. This ensures that the LCD device provides a good quality display. In addition, the alignment and the pretilt angle of the liquid crystal molecules means that the liquid crystal molecules are hybrid aligned when this is needed, and can be twisted in a very short time.

### FIELD OF THE INVENTION

The present invention relates to liquid crystal displays (LCDs), and more particularly to a transmission type LCD capable of providing a hybrid alignment mode.

### GENERAL BACKGROUND

Conventionally, there have been three types of LCD devices commercially available: a reflection type LCD device utilizing ambient light, a transmission type LCD device utilizing a backlight, and a semi-transmission type LCD device equipped with a half mirror and a backlight.

FIG. 9 shows a typical transmission type LCD device. The LCD device 1 has a first substrate 11, a second substrate 12 opposite to the first substrate 11, and a liquid crystal layer 13 sandwiched between the first and the second substrates 11, 12.

The LCD device 1 further has a common electrode 122, a second alignment film 123, which are disposed on an inner surface of the second substrate 12 in that order from top to bottom. A second retardation film 124, a second polarizer 126 are formed on an external surface of the second substrate 12 in that order from bottom to top. At the first substrate 11, a first alignment film 113 and a pixel electrode 112 are orderly set on an inner surface thereof, and a first retardation film 114 and a first polarizer 116 are orderly set on an external surface thereof.

The first and second alignment films 113, 123 are homogeneous alignment, and the polarization axes of the first and the second polarizers 116, 126 are perpendicular to each other. The common electrode 122 and the pixel electrode 112 are made from transparent material, such as indium tin oxide (ITO), or indium zinc oxide (IZO).

Because the LCD device 1 utilizes an homogeneous alignment liquid crystal layer 13, an anchoring energy between the liquid crystal molecules and the two alignment films 113, 123 is produced. Thus, a delaying time is produced for eliminating the anchoring energy when an electrical field is applied on the common and the pixel electrodes 123, 113. Therefore, the LCD device 1 has a slow response time.

What is needed, therefore, is a liquid crystal display device that overcomes the above-described deficiencies.

### SUMMARY

In a preferred embodiment, an LCD device includes a first substrate, a second substrate, and a liquid crystal layer having liquid crystal molecules is interposed between the first and second substrates. A pretilt angle of the liquid crystal layer adjacent to one of the substrates is 0° to 15°, and a pretilt angle of the liquid crystal layer adjacent to the other substrate is 75° to 90°.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of an LCD device according to a first embodiment of the present invention, which has a liquid crystal layer.

FIG. 2 shows two operation states of the liquid crystal layer of the LCD of FIG. 1, in respect of an on-state (black state) and an off-state (white state) of the LCD.

FIG. 3 shows a relationship between the luminance the LCD of FIG. 1 and the voltage applied thereon.

FIG. 4 is a schematic, exploded, side cross-sectional view of part of an LCD device according to a second embodiment of the present invention.

FIG. 5 is a schematic, exploded, side cross-sectional view of part of an LCD device according to a third embodiment of the present invention.

FIG. 6 is a schematic, exploded, side cross-sectional view of part of an LCD device according to a fourth embodiment of the present invention.

FIG. 7 is a schematic, exploded, side cross-sectional view of part of an LCD device according to a fifth embodiment of the present invention.

FIG. 8 is a schematic, exploded, side cross-sectional view of part of an LCD device according to a sixth embodiment of the present invention.

FIG. 9 is a schematic, exploded, side cross-sectional view of part of a conventional LCD device.

### DETAILED DESCRIPTION OF PREFERRED EMBODIMENTS

FIG. 1 is a schematic, exploded, side cross-sectional view of part of an LCD device 2 according to a first embodiment of the present invention. The LCD device 2 includes a first substrate 21, a second substrate 22 disposed parallel to and spaced apart from the first substrate 21, and a liquid crystal layer 23 having liquid crystal molecules (not labeled) sandwiched between the two substrates 22 and 21. The liquid crystal layer 23 is positive liquid crystal material.

A pixel electrode 212 and a first alignment film 213 are orderly formed on an inner surface of the first substrate 21, and a common electrode 222 and a second alignment film 223 are orderly formed on an inner surface of the second substrate 22. The common electrode 222 and the pixel electrode 212 are made of a transparent conductive material, such as indium-tin-oxide (ITO) or indium-zinc-oxide (IZO). A pretilt angle of the liquid crystal layer 23 adjacent to the second alignment film 223 is in a range of 0° to 15°, and a pretilt angle of the liquid crystal layer 23 adjacent to the first alignment film 213 is in a range of 70° to 90°. Thus, a hybrid alignment is formed in the liquid crystal layer 23. In addition, the liquid crystal layer 23 is mixed with chiral dopant (not labeled), for easy orienting of the liquid crystal molecules.

The LCD 2 further has a first retardation film 214 and a first polarizer 216, which are orderly disposed on an outer surface of the first substrate 21. A second retardation film 224, a second polarizer 226 are orderly disposed on an outer surface of the second substrate 22. The first and the second retardation films 214, 224 are biaxial films. The polarization axes of the first and second polarizers 216, 226 are perpendicular to each other.

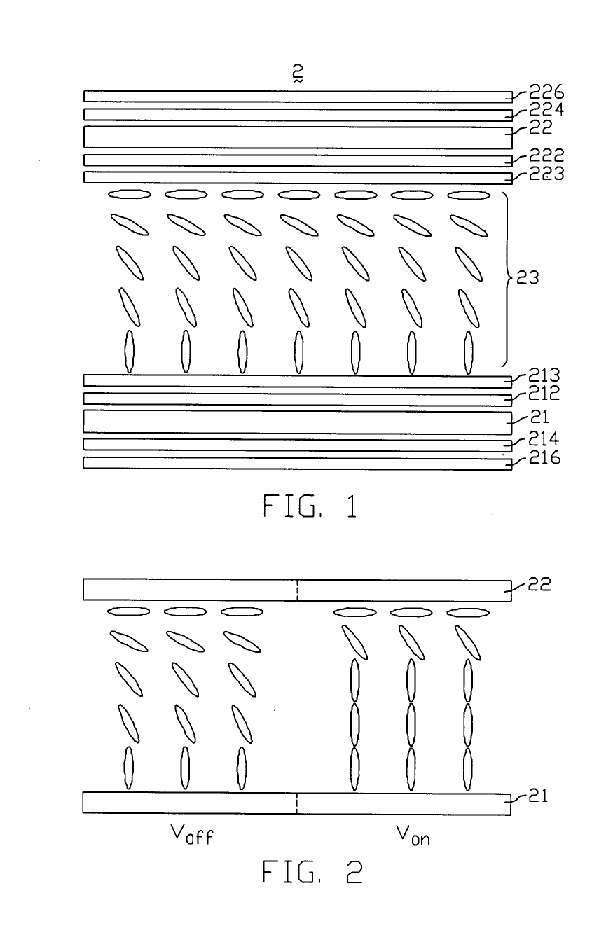

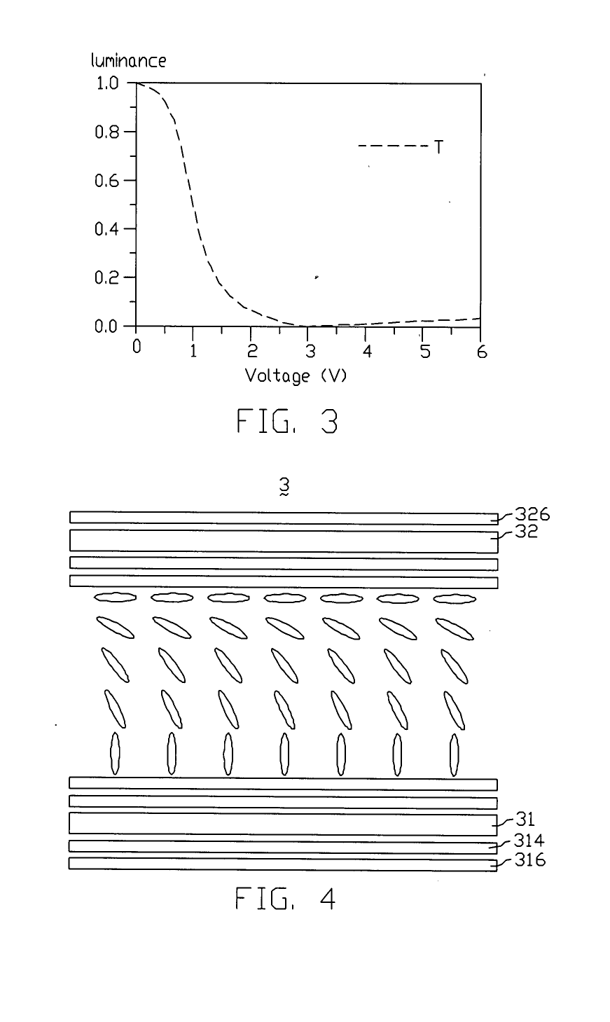

FIG. 2 shows two operation states of the liquid crystal layer 23 of the LCD 2, in respect of an on-state (black state) and an off-state (white state) of the LCD. FIG. 3 shows a relationship between the luminance the LCD 2 and the voltage applied thereon. In an off-state (white state), no voltage is provided, the liquid crystal moleculars adjacent to the first alignment film 213 is vertically aligned, and the liquid crystal moleculars adjacent to the second alignment film 223 is homogeneous aligned, the optical retardation value is half wave. When light beams pass through the liquid crystal layer 23, its polarization state is rotated 90 degrees, and the light beams pass through the second polarizer 226. Thus, the LCD 2 displays a white state. In an on-state (black state), a voltage is provided thereon, the liquid crystal moleculars of the liquid crystal layer 23 rotate following the electrical filed direction. When the voltage is 3V, the liquid crystal moleculars of the liquid crystal layer 23 rotates to perpendicular to the first and the second substrates 21, 22, no retardation is produced at the liquid crystal layer 23, and no light beams can pass through the liquid crystal layer 23. Thus, the LCD 2 displays a black state.

Because the LCD 2 utilizes an hybrid alignment liquid crystal layer 23, no anchoring force is needed to be eliminate. Thus, a threshold voltage for the liquid crystal moleculars is zero. In addition, the vertical alignment of the liquid crystal moleculars has a weak anchoring force. Thus, the liquid crystal moleculars can be rapidly rotated to a predetermined position under the provided voltage. Therefore, the LCD 2 has a rapid response time.

In addition, in use, the liquid crystal moleculars adjacent to the second substrate 22 can not be rotated to a vertical state, which effluences a viewing angle. The first and the second retardation films 214, 224 are used to compensate the phase difference, for increasing the viewing angle. A retardation relationship between the liquid crystal layer 23 and the first and the second retardation films 214, 224 satisfies the following function:

$${Ret}_{LC} ( 0 V ) - {Ret}_{LC} ( {V}_{op} ) = \frac{λ}{2} \pm m λ , m = 0 , 1 , 2 …$$

$${Ret}_{LC} ( {V}_{op} ) + {Ret}_{1} ( {0}^{°} ) + {Ret}_{2} ( {0}^{°} ) = m λ , m = 0 , 1 , 2 …$$

### In the first embodiment,

$${Ret}_{LC} ( 0 V ) - {Ret}_{LC} ( 3 V ) = \frac{λ}{2}$$

$${Ret}_{LC} ( 3 V ) + {Ret}_{1} ( {0}^{°} ) + {Ret}_{2} ( {0}^{°} ) = 0$$

wherein Ret_{LC} is the retardation value of the liquid crystal layer 23, Ret₁ is the retardation value of the first retardation film 214, Ret₂ is the retardation value of the second retardation film 224, and Vₒₚ is the loaded voltage. In the first embodiment, the operation voltage is 3V.

Thus, the LCD 2 needs a low operation voltage, just 3V. In addition, the LCD 2 has a good viewing angle under the compensation of the first and the second retardation films 214, 224.

In other modification embodiments, the liquid crystal moleculars of the liquid crystal layer 23 can also be negative liquid crystal materials. One of the first and the second retardation films 214, 224 can be an A-plate retardation film, and the other of the first and the second retardation films 214, 224 can be a discotic molecular film. In an alternate modification, the first and the second retardation films 214, 224 can all be A-plate retardation film.

FIG. 4 is a schematic, exploded, side cross-sectional view of part of an LCD 3 according to a second embodiment of the present invention. The LCD 3 is similar to the LCD device 2 of FIG. 1. However, the LCD device 3 includes a retardation film 314 is disposed between a first polarizer 316 and a first substrate 31. And no retardation film is provided between a second polarizer 326 and a second substrate 32. The retardation film 314 is a discotic liquid crystal molecular film, a pretilt angle of the discotic liquid crystal molecular film adjacent to the first substrate 31 is in a range of 45° to 90°, and a pretilt angle of the discotic liquid crystal molecular film far away the first substrate 31 is in a range of 0° to

FIG. 5 is a schematic, exploded, side cross-sectional view of part of an LCD 4 according to a third embodiment of the present invention. The LCD 4 is similar to the LCD device 3 of FIG. 4. However, the LCD device 4 includes two retardation films 414, 415, orderly disposed between a first polarizer 416 and a first substrate 41. The retardation film 414 adjacent to the first substrate 41 is a discotic molecular film, and the other retardation film 415 adjacent to the first polarizer 416 is an A-plate retardation film.

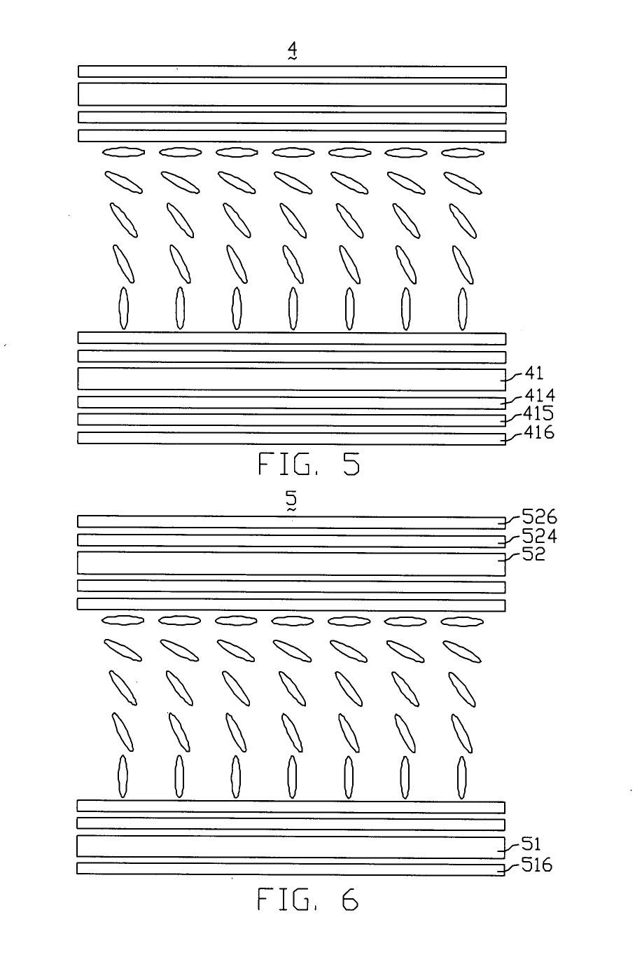

FIG. 6 is a schematic, exploded, side cross-sectional view of part of an LCD 5 according to a fourth embodiment of the present invention. The LCD 5 is similar to the LCD device 2 of FIG. 1. However, the LCD device 5 includes a retardation film 524 is disposed between a second polarizer 526 and a second substrate 52. And no retardation film is provided between the first polarizer 516 and the first substrate 51. The retardation film 524 is a discotic liquid crystal molecular film, a pretilt angle of the discotic liquid crystal molecular film adjacent to the second substrate 52 is in a range of 0° to 45°, and a pretilt angle of the discotic liquid crystal molecular film far away the second substrate 52 is in a range of 45° to 90°.

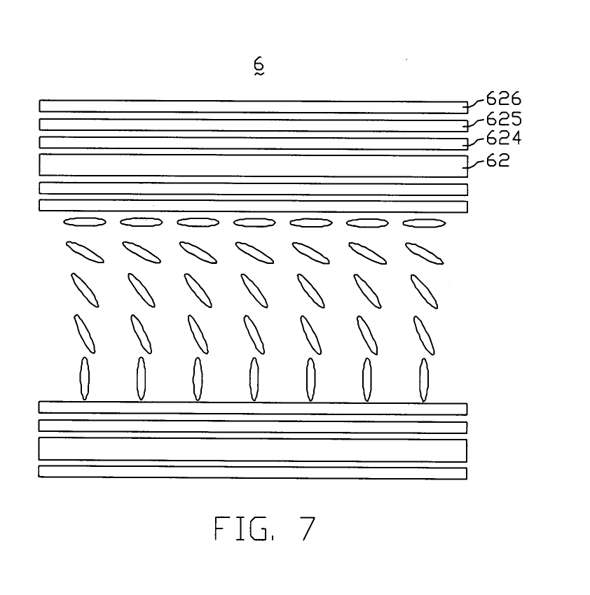

FIG. 7 is a schematic, exploded, side cross-sectional view of part of an LCD 6 according to a fifth embodiment of the present invention. The LCD 6 is similar to the LCD device 5 of FIG. 6. However, the LCD device 6 includes two retardation films 624, 625, orderly disposed between a second polarizer 626 and a second substrate 62. The retardation film 624 adjacent to the second substrate 62 is a discotic molecular film, and the other retardation film 625 adjacent to the second polarizer 626 is an A-plate retardation film.

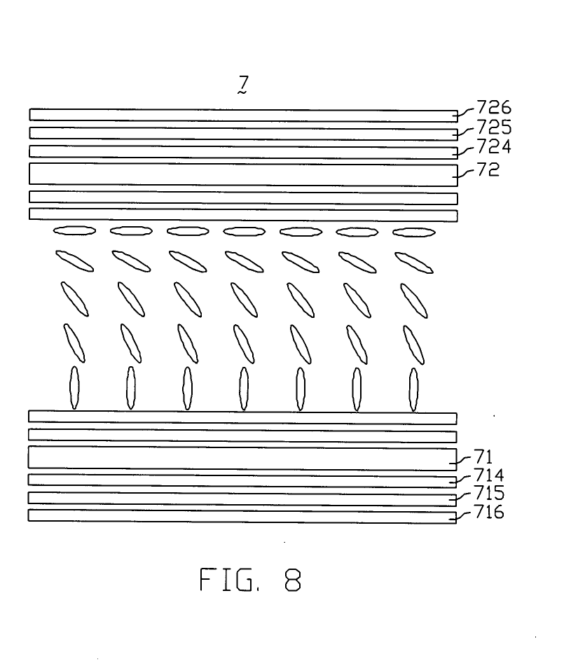

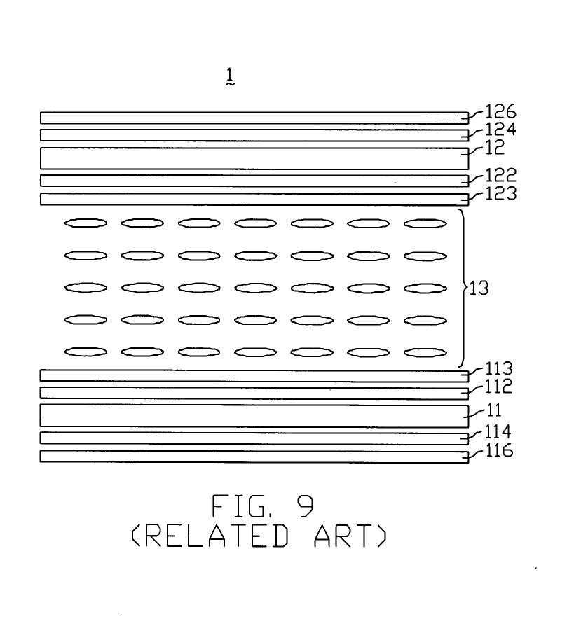

FIG. 8 is a schematic, exploded, side cross-sectional view of part of an LCD 7 according to a sixth embodiment of the present invention. The LCD 7 is similar to the LCD device 6 of FIG. 7. However, the LCD device 7 includes a first retardation film 714 and a third retardation film 715, orderly disposed between a first substrate 71 and a first polarizer 716, and a second retardation film 724 and a fourth retardation film 725, orderly disposed between a second substrate 72 and a second polarizer 726. The first retardation film 714 is adjacent to the first substrate 71, and the second retardation film 724 is adjacent to the second substrate 72. The first and the second retardation films 714, 724 are discotic molecular films, and the third and the fourth retardation films 715, 725 are A-plate retardation films. A pretilt angle of the first retardation film 714 adjacent to the first substrate 71 is in a range of 45° to 90°, and a pretilt angle of the first retardation film 714 far away the first substrate 71 is in a range of 0° to 45°. A pretilt angle of the second retardation film 724 adjacent to the second substrate 72 is in a range of 0° to 45°, and a pretilt angle of the second retardation film 724 far away the second substrate 72 is in a range of 45° to 90°.

Various modifications and alterations are possible within the ambit of the invention herein. For example, the retardation films may be biaxial compensation films, single compensation films, A-plate compensation films, or discotic molecular films. In addition, the LCD may employ only a single compensation film disposed on either the first substrate or on the second substrate. Furthermore, any or all of the retardation films and compensation films may be disposed on or at inner surfaces of either of the first and second substrates.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a first substrate and a second substrate;
a liquid crystal layer having liquid crystal molecules interposed between the first and second substrates, wherein a pretilt angle of the liquid crystal layer adjacent to one of the substrates is in a range of 0° to 15°, and a pretilt angle of the liquid crystal layer adjacent to the other substrate is in a range of 70° to 90°.

2. The liquid crystal display as claimed in claim 1, wherein a first alignment film is disposed on an inner surface of the first substrate, and a second alignment film is disposed on an inner surface of the second substrate.

3. The liquid crystal display as claimed in claim 1, wherein a first polarizer is provided at the first substrate, and a second polarizer is provided at the second substrate.

4. The liquid crystal display as claimed in claim 3, wherein the first polarizer has a polarizing axis perpendicular to a polarizing axis of the second polarizer.

5. The liquid crystal display as claimed in claim 3, further comprising a first and a second retardation films, the first retardation film being disposed between the first substrate and the first polarizer, and the second retardation film being disposed between the second substrate and the second polarizer.

6. The liquid crystal display as claimed in claim 5, wherein the first and the second retardation films are biaxial compensation film.

7. The liquid crystal display as claimed in claim 5, wherein the first and the second retardation films are A-plate compensation films.

8. The liquid crystal display as claimed in claim 5, wherein one of the first and the second retardation films can be A-plate compensation film, and the other of the first and the second retardation films can be discotic molecular film.

9. The liquid crystal display as claimed in claim 3, wherein only one retardation film is provided between the first substrate and the first polarizer.

10. The liquid crystal display as claimed in claim 9, wherein a pretilt angle of the retardation film adjacent to the first substrate is in a range of 45° to 90°, and a pretilt angle of the retardation film far away the first substrate is in a range of 0° to 45°.

11. The liquid crystal display as claimed in claim 3, wherein only one retardation film is provided between the second substrate and the second polarizer.

12. The liquid crystal display as claimed in claim 11, wherein a pretilt angle of the retardation film adjacent to the second substrate is in a range of 0° to 45°, and a pretilt angle of the retardation film far away the second substrate is in a range of 45° to 90°.

13. The liquid crystal display as claimed in claim 3, wherein two retardation films are provided between the first substrate and the first polarizer.

14. The liquid crystal display as claimed in claim 13, wherein the retardation film adjacent to the first substrate is a discotic molecular film, and the other retardation film is A-plate retardation film.

15. The liquid crystal display as claimed in claim 13, further comprising two retardation films, provided between the second substrate and the second polarizer.

16. The liquid crystal display as claimed in claim 15, wherein the retardation film adjacent to the second substrate is a discotic molecular film, and the other retardation film is A-plate retardation film.
